(19) United States
(12) Patent Application Publication
(10) Pub. No.: US 2010/0192311 A1
(43) Pub. Date: Aug. 5, 2010

(54) METHOD FOR PERFUMING FABRICS

(76) Inventors: Euan John Magennis, Newcastle (GB); Graene Duncan Cruickshank, Newcastle (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/685,079

(22) Filed: Jan. 11, 2010

(30) Foreign Application Priority Data
Jan. 30, 2009 (EP) 09151822.5

(51) Int. Cl. D06L 1/00; C11D 3/00

(52) U.S. Cl. 8/142; 8/137

(57) ABSTRACT

Method of perfuming a fabric article in a laundry appliance comprising the steps of:
a) placing the article in the appliance;
b) delivering a perfume composition onto the article wherein the composition comprises:
   i) from 0.01% to 10% by weight of the composition of perfume and the perfume comprises:
      at least 5% by weight of perfume blooming ingredients having a boiling point at 1 atmosphere of less than 260° C. and preferably a Clog P greater than 3 at 25° C.; and
      at least 1% by weight of perfume fabric substantive ingredients having a boiling point at 1 atmosphere of more than 260° C. and a Clog P greater than 3 at 25° C.; and
   ii) from 0.01% to 10% by weight of the composition of a preservative.

### TECHNICAL FIELD

The present invention is in the field of fabric treatment. In particular, it relates to a method of perfuming fabrics in a laundry appliance comprising the step of delivering a perfume composition onto the fabrics.

### BACKGROUND OF THE INVENTION

Nowadays cleaning of fabrics not only requires the removal of soils but the user also expect the fabrics to end up with a pleasant odour as part of the cleaning process. The perfuming of fabrics is traditionally done from detergent delivered into the wash cycle of a laundry washing machine, however this is not a simple task. On one hand a high concentration of perfume is required to provide good perfuming of the fabrics because the detergent becomes highly diluted in the wash liquor reducing the perfume concentration. On the other hand, some of the perfume is rinsed off during the rinse cycle. As consequence this form of perfume delivery is suboptimal. Washing is followed by drying. High temperatures are involved when the drying takes place in a dryer, this can contribute to perfume evaporation, reducing the amount of perfume remaining on the fabrics even further.

Users expect that not only the fabrics are perfumed but also that the area in which the cleaning process takes place benefits from a pleasant smell. To achieve these two objectives simultaneously, i.e., to perfume the area where the cleaning takes place and to end up with perfumed fabrics, is not easy. This is particularly challenging in the case in which drying takes place in a dryer because the drying process involves high temperatures that can contribute to perfume evaporation and as consequence not much perfume would remain on the treated fabrics.

WO 2004/094580 describes a method for delivering a treatment composition comprising volatile materials to a fabric article. The treatment composition comprises a perfume that comprises at least about 30% by weight of a perfume material with a boiling point of less than or equal to 250° C. at 1 atmosphere. The composition is applied using a dryer with a set temperature or time profile. The compositions of '580 can initially provide good perfume of the fabric articles but it might not be substantive enough to provide long last perfuming. There is a need for an efficient process for the perfuming of fabrics using low amounts of perfume and at the same time the process should provide perfume to the cleaning area so the user can have an added benefit during the drying process to make the experience more enjoyable.

### SUMMARY OF THE INVENTION

The present invention is directed to methods of perfuming a fabric article by delivering a perfume composition onto a fabric article in a laundry appliance. The perfume composition comprises blooming perfume ingredients and fabric substantive perfume ingredients. The composition provides perfuming of the area where the laundry takes place (for example, the laundry room) and at the same time perfuming of the fabrics. The composition for use in the method of the invention is not appliance substantive and does not leave residues on the appliances.

According to a first aspect of the invention, there is provided a method of perfuming a fabric article in a dryer comprising the steps of:

a) placing the article in the dryer;
b) delivering a perfume composition onto the article wherein the article has a low level of moisture. The level of moisture is less than about 0.5 l/kg, preferably less than about 0.1 l/kg, more preferably less than about 0.05 l/kg.

If too much moisture remains on the fabric further drying of the items will remove water from the fabric but also will remove some perfume ingredients through evaporation. Therefore, to ensure maximum residual perfume the moisture level must be less than about 0.5 l/kg, preferably less than about 0.1 l/kg, more preferably less than about 0.05 l/kg. The level of moisture is measured according to the “bone dry” method as described in International Electrotechnical Commission method 60456.

The composition comprises:
i) from about 0.01% to about 10%, preferably from about 0.02% to about 2% and more preferably from about 0.1% to about 1% of perfume by weight of the composition and the perfume comprises:
   at least 5%, preferably at least 10%, more preferably at least 20% and especially at least 40% by weight of the perfume of perfume blooming ingredients having a boiling point at 1 atmosphere of less than 260° C. and preferably a Clog P greater than 3 at 25° C.; and
   at least 1%, preferably at least 2%, more preferably at least 5% and especially at least 6% by weight of the perfume of perfume fabric substantive ingredients having a boiling point at 1 atmosphere of more than 260° C. and a Clog P greater than 3 at 25° C.; and
ii) from 0.001% to 10%, preferably from 0.01% to 5%, more preferably from 0.02 to 1% by weight of the composition of a preservative.

The composition for use in the methods of the invention is sometimes herein referred to as “composition of the invention”. The composition of the invention provides good perfuming using a relatively low level of perfume. The amount of perfume deposited on a fabric article using the method of the invention is high compared to traditional methods (i.e., traditional laundry wherein the perfume is delivered from the main wash detergent) and even compared to other methods of delivering fabric care compositions in a dryer.

The methods of the invention produce perfumed fabric articles and at the same time provide perfuming of the area where the articles are being dried. The perfume deposited on fabric articles according to the method of the invention has high fabric substantivity allowing for a long lasting effect. For substantivity reasons not only the boiling point is important but also the Clog P. ClogP is a measure of differential solubility or rather hydrophobicity as the octanol/water coefficient. As such the higher this value the more hydrophobic a substance becomes. It is important that for substantive perfume ingredients ClogP is greater than 3 to ensure adhesion to the fabric surface over partitioning in the aqueous carrier.

In a preferred embodiment the fabric article treated is a dry article. By “dry article” herein is meant an article having less than 0.01%, preferably less than 0.001% of water by weight of the article, as measured by the bone dry method. The article can be dry because it has not been washed or because it has gone through a drying cycle before being subjected to the method of the invention. Delivery of the composition onto dry articles is particularly advantageous in the case in which the articles, in particular clothes, are not dirty, they have been worn only once or a couple of times and the user would like to refresh them rather than subject them to the whole cleaning process, not only because of the time, energy and resources but also because the cleaning process may contribute to wear and tear of the clothes.

The method of the invention is not only suitable for the treatment of wet or dry fabric articles but it is also suitable for perfuming a mixture of dry and wet articles. It has been found that when a mixture of wet and dry articles is treated, both, the dry and the wet articles benefit from each other's presence. The dry articles become slightly damp, contributing to wrinkle elimination and reducing the amount of electrostatic charge on the fabric article and the wet articles dry faster.

In preferred embodiments the delivery of the perfume composition takes place in the dryer when the drum is stationary, preferably in the absence of an air current. This avoids losses of the perfume composition within the air current.

In other embodiments, the delivery takes place in the dryer when the drum is tumbling in the absence or presence of an air current, preferably in the absence of an air current. This contributes to a uniform and efficient distribution of the perfume composition onto the fabric articles.

Tumble dryers have been traditionally used only to dry wet fabrics. The method of the invention allows for a new application of the dryers, i.e., to treat dry fabrics in order to perfume them.

According to another aspect of the invention, there is provided a method that takes place in a washing machine and the composition is delivered after the final rinse cycle, either before or after the spinning cycle, with either rotation of the drum or with the drum stationary. Rotation of the drum contributes to a uniform distribution of the perfume. After the perfume composition has been applied onto the articles, the articles can be dried on a laundry rack or in a dyer. In both instances the method of the invention provides excellent perfuming of the fabrics. It permits the deposition of perfume in a more efficient way than a traditional laundry process, i.e., from a main wash detergent. In a traditional laundry process the perfume is diluted in the wash liquor moreover the perfume can be partially or totally removed in the rinse.

In preferred embodiments the preservative is selected from chelants, organic sulphur compounds, halogenated compounds, cyclic organic nitrogen compounds, low molecular weight aldehydes, dehydroacetic acid, phenyl and phenolic compounds and parabens. Preferably the composition is free of quaternary ammonium compounds.

In preferred embodiments the composition of the invention comprises cyclodextrins that help to prevent malodours on the fabric articles.

In an especially preferred embodiment, the delivery of the perfume composition takes place intermittently, preferably when the drum is rotating. Very good and uniform deposition is achieved when part of the composition is delivered when the drum is rotating, following by a period of no delivery with the drum still rotating, this process is repeated a number of times. If the process is taking place in a dryer, it is preferred not to have an air current or heat during the delivery periods.

The laundry appliances for use in the method of the invention are usually equipped with a liquid delivery system comprising an inlet, a reservoir, a delivery means and an outlet. The inlet is preferably in the form of an openable drawer, preferably located on the front of the appliance. The reservoir is charged from the inlet. It should be suitable to hold a single dose (so each dose can be a different product, given the user maximum flexibility) and/or a plurality of doses (so the user does not need to fill it each time that the appliance is used, thereby simplifying the task). The reservoir could have different compartments for storage of different compositions that can be delivered simultaneously or separately (providing maximum flexibility and task simplification).

The delivery means preferably comprises a pump, more preferably an electric pump. Additionally the delivery means can comprise electrostatic means or ultrasonic means, especially piezo electric ultrasonic means, have been found to be especially suitable from a uniform and efficient delivery viewpoint.

The outlet is preferably closable so it can be closed when no delivery of liquid is taking place. This can help to avoid clogging of the outlet by for example lint generated during the drying process in a dryer or soil generated during the washing process in a washing machine. It also contributes to maintain the perfume composition thermally isolated. In a preferred embodiment the outlet is in the form of a nozzle or a plurality of nozzles, preferably placed in a manner that will provide good uniformity of distribution and deposition of the perfume composition.

Preferably, the perfume composition is delivered in the form of a spray preferably having:

a) droplets having a mean particle size of from about 100 microns to about 1400 microns, more preferably from about 200 microns to about 1300 microns, even more preferably from about 300 microns to about 1200 microns and especially from about 500 microns to about 1100 microns; and preferably
b) a flowrate of from about 0.5 to about 100 ml/min, more preferably from about 1 to about 75 ml/minute, even more preferably from about 2 to about 50 ml/minute and especially from about 15 to about 25 ml/minute.

### DETAILED DESCRIPTION OF THE INVENTION

The present invention envisages methods of perfuming a fabric article in a laundry appliance by delivering a perfume composition wherein the perfume comprises blooming and fabric substantive ingredients. The method provides a very efficient way to perfume fabrics, in terms of perfume amounts required and long lasting effect, and provides excellent perfuming of the treated fabrics as well as perfume of the laundry room.

By laundry appliance is herein meant an appliance used in any of the steps of cleaning of fabrics (including traditional cleaning, refreshing and finishing of the fabrics). Preferred appliances for use herein are washing machines (with and without drying capabilities) and dryers, more preferably tumble dryers.

### Perfume Composition

The perfume composition for use herein is preferably an aqueous composition having as essential components a perfume, comprising blooming and fabric substantive perfume ingredients, and a preservative. The composition is preferably free from materials which leave deposits or stain fabrics.

The perfume comprises at least about 5%, preferably from about 6% to about 70%, more preferably from about 10% to about 60% and especially from about 15% to about 50% by weight of perfume blooming ingredients. The perfume blooming ingredients have a boiling point at 1 atmosphere of less than about 260° C., preferably less than about 250° C., more preferably less than 240° C. and preferably a Clog P at 25° C. greater than 3; and

at least about 1%, preferably from about 2% to about 30%, more preferably from about 4% to about 20% and especially from about 5% to about 15% by weight of perfume fabric substantive ingredients having a boiling point of more than 260° C. at 1 atmosphere and a Clog P at 25° C. greater than 3.

### Blooming Perfume Ingredients

A blooming perfume ingredient is characterized by its boiling point (B.P.) and its octanol/water partition coefficient (P). The octanol/water partition coefficient of a perfume ingredient is the ratio between its equilibrium concentrations in octanol and in water. The preferred perfume ingredients of this invention have a B.P., determined at the normal, standard pressure of about 760 mm Hg (1 atmosphere), of about 260° C. or lower, preferably less than about 255° C.; and more preferably less than about 250° C., and an octanol/water partition coefficient P of about 1,000 or higher. Since the partition coefficients of the preferred perfume ingredients of this invention have high values, they are more conveniently given in the form of their logarithm to the base 10, logP. Thus the preferred perfume ingredients of this invention have logP at 25° C. of about 3 or higher.

Boiling points of many perfume compounds can be found in the following sources:
Properties of Organic Compounds Database CD-ROM Ver. 5.0
CRC Press
Boca Raton, Fla.
Flavor and Fragrance—1995
Aldrich Chemical Co.
Milwaukee, Wis.
STN database/on-line
Design Institute of for Physical Property Data
American Institute of Chemical Engineers
STN database/on-line
Beilstein Handbook of Organic Chemistry
Beilstein Information Systems
Perfume and Flavor Chemicals
Steffen Arctander
Vol. I, II—1969

When unreported, the 760 mm boiling points of perfume ingredients can be estimated. The following computer programs are useful for estimating these boiling points:
MPBPVP Version 1.25© 1994-96 Meylan
Syracuse Research Corporation (SRC)
Syracuse, N.Y.
ZPARC
ChemLogic, Inc.
Cambridge, Mass.

For the purpose of the present invention the boiling point of the perfume ingredients is preferably the measured boiling point.

The logP of many perfume ingredients has been reported; for example, the Pomona92 database, available from Daylight Chemical Information Systems, Inc. (Daylight CIS), Irvine, Calif., contains many, along with citations to the original literature. However, the logP values are most conveniently calculated by the Pamona Med Chem/Daylight “CLOGP” program, Version 4.42 available from Biobyte Corporation, Claremont, Calif. This program also lists experimental logP values when they are available in the Pomona92 database. The “calculated logP” (ClogP) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990, incorporated herein by reference). The fragment approach is based on the chemical structure of each perfume ingredient, and takes into account the numbers and types of atoms, the atom connectivity, and chemical bonding. The ClogP values, which are the most reliable and widely used estimates for this physicochemical property, are preferably used instead of the experimental logP values in the selection of perfume ingredients which are useful in the present invention. Unless stated otherwise the Clog P values herein are determined by the fragment approach of Hansch and Leo.

The perfume used according to the method of the invention is very effusive and very noticeable during use. The blooming perfume ingredients have low odour detection level, permitting the use of low amounts while still providing an odour of the desired intensity. The composition of the invention not only has a pleasant odour but also is capable of boosting the odour when the composition is in use.

Table 1 gives some non-limiting examples of blooming perfume ingredients, useful in the compositions of the present invention. The perfume of the present invention preferably contain at least 5 different blooming perfume ingredients, preferably at least 6 different blooming perfume ingredients, more preferably at least 7 different blooming perfume ingredients, and even more preferably at least 8 or 9 or even 10 or more different blooming perfume ingredients. A variety of blooming ingredients is necessary to create the right complexity of odors that would create a perfume with the desired character. Furthermore, the perfume of the present invention preferably contains at least about 50 wt. % of blooming perfume ingredients, preferably at least about 55 wt. % of blooming perfume ingredients, more preferably at least about 60 wt. % of blooming perfume ingredients. The perfume herein preferably should not contain any single blooming ingredient at a level that would provide, by weight, more than about 2% of that ingredient to the total blooming perfume ingredients, more preferably not more than about 1.5%, and even more preferably not more than about 0.5%, of the blooming perfume ingredients.

The perfume itself preferably should not contain more than 60% of any single perfume ingredient.

Most common perfume ingredients which are derived from natural sources are composed of a multitude of components. For example, orange terpenes contain about 90% to about 95% d-limonene, but also contain many other minor ingredients. When each such material is used in the formulation of blooming perfume compositions of the present invention, it is counted as one ingredient, for the purpose of defining the invention. Synthetic reproductions of such natural perfume ingredients are also comprised of a multitude of components and are counted as one ingredient for the purpose of defining the invention.

TABLE 1
Examples of Blooming Perfume Ingredients

| | | | Boiling |
|---|---|---|---|
| | ClogP | Boiling Pt. | Pt. |
| Ingredient | (Pred.) | (Meas.) | (Pred.) |
| Allo-ocimene | 4.36 | | 195 |
| Allyl cyclohexanepropionate | 3.94 | | 252 |
| Allyl heptanoate | 3.40 | | 209 |
| trans-Anethole | 3.31 | 232 | |
| Benzyl butyrate | 3.02 | 240 | |
| Camphene | 4.18 | 160 | |
| Cadinene | 7.27 | | 252 |
| Carvacrol | 3.40 | 238 | |
| cis-3-Hexenyl tiglate | 3.80 | | 225 |
| Citronellol | 3.25 | 223 | |
| Citronellyl acetate | 4.20 | 234 | |
| Citronellyl nitrile | 3.09 | 226 | |
| Citronellyl propionate | 4.73 | | 257 |
| Cyclohexylethyl acetate | 3.36 | 222 | |
| Decyl Aldehyde (Capraldehyde) | 4.01 | 208 | |
| Delta Damascone | 3.62 | | 256 |
| Dihydromyrcenol | 3.03 | 192 | |
| Dihydromyrcenyl acetate | 3.98 | | 221 |
| 3,7-Dimethyl-1-octanol | 3.74 | 205 | |
| Diphenyloxide | 4.24 | 259 | |
| Fenchyl Acetate | 3.53 | | 234 |
| (1,3,3-Trimethyl-2-norbornanyl acetate) | | | |
| Geranyl acetate | 3.72 | 233 | |
| Geranyl formate | 3.27 | | 231 |
| Geranyl nitrile | 3.25 | 228 | |
| cis-3-Hexenyl isobutyrate | 3.27 | | 204 |
| Hexyl Neopentanoate | 4.06 | | 213 |
| Hexyl tiglate | 4.28 | | 221 |
| alpha-Ionone | 3.71 | 237 | |
| Isobornyl acetate | 3.53 | 238 | |
| Isobutyl benzoate | 3.57 | 242 | |
| Isononyl acetate | 4.28 | | 220 |
| Isononyl alcohol | 3.08 | 194 | |
| (3,5,5-Trimethyl-1-hexanol) | | | |
| Isopulegyl acetate | 3.70 | | 243 |
| Lauraldehyde | 5.07 | 250 | |
| d-Limonene | 4.35 | 177 | |
| Linalyl acetate | 3.50 | | 230 |
| Lorysia | 4.06 | | 236 |
| D-limonene | 4.35 | | 177 |
| Lymolene | 3.03 | | 198 |
| (−)-L-Menthyl acetate | 4.18 | 227 | |
| Methyl Chavicol (Estragole) | 3.13 | 216 | |
| Methyl n-nonyl acetaldehyde | 4.85 | 247 | |
| Methyl octyl acetaldehyde | 4.32 | | 224 |
| beta--Myrcene | 4.33 | | 165 |
| Neryl acetate | 3.72 | 236 | |
| Nonyl acetate | 4.41 | 229 | |
| Nonaldehyde | 3.48 | 191 | |
| Para-Cymene | 4.07 | 173 | |
| alpha-Pinene | 4.18 | 156 | |
| beta--Pinene | 4.18 | 166 | |
| alpha-Terpinene | 4.41 | 175 | |
| gamma-Terpinene | 4.35 | 183 | |
| Terpineolene | 4.35 | | 172 |
| alpha-Terpinyl acetate | 3.58 | 220 | |
| Tetrahydrolinalool | 3.52 | 202 | |
| Tetrahydromyrcenol | 3.52 | 195 | |
| 2-Undecenal | 4.22 | | 235 |
| Verdox (o-t-Butylcyclohexyl acetate) | 4.06 | | 239 |
| Vertenex (4-tert.Butylcyclohexyl acetate) | 4.06 | | 237 |

### Fabric Substantive Perfume Ingredients

The perfume composition of present invention also comprises from about 0.5% to about 10%, preferably from about 1% to about 9%, more preferably from about 1.5% to about 8%, and most preferably from about 2% to about 7%, of fabric substantive perfume ingredients having a B.P. at 1 atmosphere of more than about 260° C. and having a ClogP at 25° C. of at least about 3. These ingredients are particularly effective on providing long last perfuming of fabric articles. Table 2 provides some non-limiting examples of such fabric substantive perfume ingredients.

In the following table, measured boiling points are taken from the above-mentioned sources. Estimated boiling points are an average of those determined by the above-mentioned computer programs.

The predicted ClogP at 25° C. was determined by the following computer program:
Panoma MedChem/Daylight ClogP V. 4.42

TABLE 2
Examples of “Fabric Substantive” Perfume Ingredients

| | | | Boiling |
|---|---|---|---|
| | ClogP | Boiling Pt. | Pt. |
| Ingredient | (Pred.) | (Meas.) | (Pred.) |
| (Ambrettolide) | 6.36 | | 352 |
| Oxacycloheptadec-10-en-2-one | | | |
| (Amyl benzoate) n-Pentyl benzoate | 4.23 | | 263 |
| Isoamyl cinnamate | 4.45 | | 300 |
| alpha-Amylcinnamaldehyde | 4.32 | 289 | |
| alpha-Amylcinnamaldehyde | 4.03 | | 320 |
| dimethyl acetal | | | |
| (iso-Amyl Salicylate) isopentyl salicylate | 4.43 | 277 | |
| (Aurantiol) Methyl | 4.22 | | 413 |
| anthranilate/hydroxycitronellal Schiff base | | | |
| Benzophenone | 3.18 | 305 | |
| Benzyl salicylate | 4.21 | 320 | |
| beta-Caryophyllene | 6.45 | | 263 |
| Cedrol | 4.53 | | 274 |
| Cedryl acetate | 5.48 | | 289 |
| Cinnamyl cinnamate | 4.64 | | 387 |
| Citrathal | 3.93 | | 262 |
| Citronellyl isobutyrate | 5.04 | | 266 |
| Clonal | 4.90 | | 267 |
| Cyclohexyl salicylate | 4.48 | | 327 |
| Cyclamen aldehyde | 3.46 | | 271 |
| Cyclabute | 3.41 | | 275 |
| delta-Dodecalactone | 4.39 | | 279 |
| (Dihydro Isojasmonate) Methyl 2-hexyl-3- | 3.09 | | 314 |
| oxo-cyclopentanecarboxylate | | | |
| Diphenylmethane | 4.06 | 265 | |
| Ethylene brassylate | 4.62 | | 390 |
| Ethyl undecylenate | 4.99 | 261 | |
| Florhydral | 3.55 | | 277 |
| Iso E Super | 4.85 | | 306 |
| (Exaltolide) Pentadecanolide | 6.29 | | 338 |
| (Galaxolide) 4,6,6,7,8,8-Hexamethyl- | 6.06 | | 335 |
| 1,3,4,6,7,8-hexahydro-cyclopenta(G)-2- | | | |
| benzopyran | | | |
| gamma-Methyl Ionone | 4.02 | | 278 |
| (alpha-Isomethylionone) | | | |
| Geranyl isobutyrate | 5.00 | | 295 |
| Habanolide | 6.29 | | 330 |
| Hexadecanolide | 6.85 | | 352 |
| cis-3-Hexenyl salicylate | 4.61 | | 323 |
| alpha-Hexylcinnamaldehyde | 4.85 | | 334 |
| n-Hexyl salicylate | 5.09 | | 318 |
| Hexadecanolide | 6.85 | | 352 |
| Ionone Beta | 3.77 | | 276 |
| alpha--Irone | 4.23 | | 279 |
| Iso E Super | 4.85 | | 306 |
| 6-Isobutylquinoline | 3.99 | | 294 |
| Lilial (p-tert.Butyl-alpha- | 3.86 | | 282 |
| methyldihydrocinnamic aldehyde, PT | | | |
| Bucinol) | | | |
| Linalyl benzoate | 5.42 | | 325 |
| (2-Methoxy Naphthalene) beta-Naphthyl | 3.24 | 274 | |
| methyl ether | | | |
| Nectaryl | 4.43 | | 317 |
| Neobutenone | 3.63 | | 266 |
| 10-Oxahexadecanolide | 4.38 | | 355 |
| Patchouli alcohol | 4.53 | | 317 |
| (Phantolide) 5-Acetyl-1,1,2,3,3,6- | 5.69 | | 333 |
| hexamethylindan | | | |
| Phenethyl benzoate | 4.06 | | 335 |
| Phenethyl phenylacetate | 3.77 | | 350 |
| Phenyl Hexanol (3-Methyl-5-phenyl-1- | 3.17 | | 296 |
| pentanol) | | | |
| Tonalid (7-Acetyl-1,1,3,4,4,6- | 6.25 | | 344 |
| hexamethyltetralin) | | | |
| delta-Undecalactone | 3.86 | | 262 |
| gamma-Undecalactone | 3.83 | 286 | |
| Vertinert Acetate | 5.47 | | 332 |

### Preservative

The composition comprises from about 0.0001% to about 2% of antimicrobial preservative. Preferably from about 0.0002% to about 1%, more preferably from about 0.0003% to about 0.5%, most preferably from about 0.0004% to about 0.1%, by weight of the composition.

The preservative keeps the composition free from microorganisms and subsequent microbial growth that can result in unsightly and/or malodorous issues. The preservative is effective for inhibiting and/or regulating microbial growth in order to increase storage stability of the perfume composition. Preferably the preservative is water-soluble and is solubilised in the perfume composition. The composition of the invention is more prone to microbial growth when the compositions comprise cyclodextrins.

It is preferable to use a broad spectrum preservative, e.g., one that is effective on both bacteria (both gram positive and gram negative) and fungi. A limited spectrum preservative, e.g., one that is only effective on a single group of microorganisms, e.g., fungi, can be used in combination with a broad spectrum preservative or other limited spectrum preservatives with complimentary and/or supplementary activity. A mixture of broad spectrum preservatives can also be used. In some cases where a specific group of microbial contaminants is problematic (such as Gram negatives), aminocarboxylate chelators (also referred herein as chelants) may be used alone or as potentiators in conjunction with other preservatives. These chelators which include, e.g., ethylenediaminetetraacetic acid (EDTA), hydroxyethylenediaminetriacetic acid, diethylenetriaminepentaacetic acid, and other aminocarboxylate chelators, and mixtures thereof, and their salts, and mixtures thereof, can increase preservative effectiveness against Gram-negative bacteria, especially Pseudomonas species.

Antimicrobial preservatives useful in the present invention include biocidal compounds, i.e., substances that kill microorganisms, or biostatic compounds, i.e., substances that inhibit and/or regulate the growth of microorganisms.

Preferred antimicrobial preservatives are those that are water-soluble and are effective at low levels. Water-soluble preservatives useful in the present invention are those that have a solubility in water of at least about 0.3 g per 100 ml of water, i.e., greater than about 0.3% at room temperature, preferably greater than about 0.5% at room temperature.

The preservative can be any organic preservative material which will not cause damage to fabric appearance, e.g., discoloration, coloration, bleaching. The water-soluble preservatives of the composition of the invention are selected from organic sulfur compounds, halogenated compounds, cyclic organic nitrogen compounds, low molecular weight aldehydes, quaternary ammonium compounds, dehydroacetic acid, phenyl and phenolic compounds, parabens and mixtures thereof. Preferably the composition of the invention is free from quaternary ammonium compounds. Due to the nature of these species aggregates may form which can cause blockages in the delivery system or potential build up within the appliance itself.

The following are preservatives for use in the composition of the present invention.

### (1). Organic Sulfur Compounds

Preferred water-soluble preservatives for use in the present invention are organic sulfur compounds. Some non-limiting examples of organic sulfur compounds suitable for use in the present invention are:

(a) 3-Isothiazolone Compounds

A preferred preservative is an antimicrobial, organic preservative containing 3-isothiazolone groups having the formula:

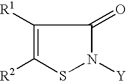

wherein

Y is an unsubstituted alkyl, alkenyl, or alkynyl group of from about 1 to about 18 carbon atoms, an unsubstituted or substituted cycloalkyl group having from about a 3 to about a 6 carbon ring and up to 12 carbon atoms, an unsubstituted or substituted aralkyl group of up to about 10 carbon atos, or an unsubstituted or substituted aryl group of up to about 10 carbon atoms;
R¹ is hydrogen, halogen, or a (C₁-C₄) alkyl group; and
R² is hydrogen, halogen, or a (C₁-C₄) alkyl group.

Preferably, when Y is methyl or ethyl, R¹ and R² should not both be hydrogen. Salts of these compounds formed by reacting the compound with acids such as hydrochloric, nitric, sulfuric, etc. are also suitable.

This class of compounds is disclosed in U.S. Pat. No. 4,265,899, Lewis et al., issued May 5, 1981, and incorporated herein by reference. Examples of said compounds are: 5-chloro-2-methyl-4-isothiazolin-3-one; 2-n-butyl-3-isothiazolone; 2-benzyl-3-isothiazolone; 2-phenyl-3-isothiazolone, 2-methyl-4,5-dichloroisothiazolone; 5-chloro-2-methyl-3-isothiazolone; 2-methyl-4-isothiazolin-3-one; and mixtures thereof. A preferred preservative is a water-soluble mixture of 5-chloro-2-methyl-4-isothiazolin-3-one and 2-methyl-4-isothiazolin-3-one, more preferably a mixture of about 77% 5-chloro-2-methyl-4-isothiazolin-3-one and about 23% 2-methyl-4-isothiazolin-3-one, a broad spectrum preservative available as a 1.5% aqueous solution under the trade name Kathon® CG by Rohm and Haas Company.

When Kathon® is used as the preservative in the present invention it is present at a level of from about 0.0001% to about 0.01%, preferably from about 0.0002% to about 0.005%, more preferably from about 0.0003% to about 0.003%, most preferably from about 0.0004% to about 0.002%, by weight of the composition.

Other isothiazolins include 1,2-benzisothiazolin-3-one, available under the trade name Proxel® products; and 2-methyl-4,5-trimethylene-4-isothiazolin-3-one, available under the trade name Promexal®. Both Proxel and Promexal are available from Zeneca. They have stability over a wide pH range (i.e., 4-12). Neither contain active halogen and are not formaldehyde releasing preservatives. Both Proxel and Promexal are effective against typical Gram negative and positive bacteria, fungi and yeasts when used at a level from about 0.001% to about 0.5%, preferably from about 0.005% to about 0.05%, and most preferably from about 0.01% to about 0.02% by weight of the usage composition.

(b) Sodium Pyrithione

Another preferred organic sulfur preservative is sodium pyrithione, with water solubility of about 50%. When sodium pyrithione is used as the preservative in the present invention it is typically present at a level of from about 0.0001% to about 0.01%, preferably from about 0.0002% to about 0.005%, more preferably from about 0.0003% to about 0.003%, by weight of the usage composition.

Mixtures of the preferred organic sulfur compounds can also be used as the preservative in the present invention.

### (2). Halogenated Compounds

Preferred preservatives for use in the present invention are halogenated compounds. Some non-limiting examples of halogenated compounds suitable for use in the present invention are:
5-bromo-5-nitro-1,3-dioxane, available under the trade name Bronidox L® from Henkel. Bronidox L® has a solubility of about 0.46% in water. When Bronidox is used as the preservative in the present invention it is typically present at a level of from about 0.0005% to about 0.02%, preferably from about 0.001% to about 0.01%, by weight of the usage composition;
2-bromo-2-nitropropane-1,3-diol, available under the trade name Bronopol® from Inolex can be used as the preservative in the present invention. Bronopol has a solubility of about 25% in water. When Bronopol is used as the preservative in the present invention it is typically present at a level of from about 0.002% to about 0.1%, preferably from about 0.005% to about 0.05%, by weight of the usage composition;
1,1′-hexamethylene bis(5-(p-chlorophenyl)biguanide), commonly known as chlorhexidine, and its salts, e.g., with acetic and gluconic acids can be used as a preservative in the present invention. The digluconate salt is highly water-soluble, about 70% in water, and the diacetate salt has a solubility of about 1.8% in water. When chlorhexidine is used as the preservative in the present invention it is typically present at a level of from about 0.0001% to about 0.04%, preferably from about 0.0005% to about 0.01%, by weight of the usage composition.
1,1,1-Trichloro-2-methylpropan-2-ol, commonly known as chlorobutanol, with water solubility of about 0.8%; a typical effective level of chlorobutanol is from about 0.1% to about 0.5%, by weight of the usage composition.
4,4′-(Trimethylenedioxy)bis-(3-bromobenzamidine) diisethionate, or dibromopropamidine, with water solubility of about 50%; when dibromopropamidine is used as the preservative in the present invention it is typically present at a level of from about 0.0001% to about 0.05%, preferably from about 0.0005% to about 0.01% by weight of the usage composition.

Mixtures of the preferred halogenated compounds can also be used as the preservative in the present invention.

### (3). Cyclic Organic Nitrogen Compounds

Preferred water-soluble preservatives for use in the present invention are cyclic organic nitrogen compounds. Some non-limiting examples of cyclic organic nitrogen compounds suitable for use in the present invention are:

(a) Imidazolidinedione Compounds

Preferred preservatives for use in the present invention are imidazolidione compounds. Some non-limiting examples of imidazolidinedione compounds suitable for use in the present invention are:
1,3-bis(hydroxymethyl)-5,5-dimethyl-2,4-imidazolidinedione, commonly known as dimethyloldimethylhydantoin, or DMDM hydantoin, available as, e.g., Glydant® from Lonza. DMDM hydantoin has a water solubility of more than 50% in water, and is mainly effective on bacteria. When DMDM hydantoin is used, it is preferable that it be used in combination with a broad spectrum preservative such as Kathon CG®, or formaldehyde. A preferred mixture is about a 95:5 DMDM hydantoin to 3-butyl-2-iodopropynylcarbamate mixture, available under the trade name Glydant Plus® from Lonza. When Glydant Plus® is used as the preservative in the present invention, it is typically present at a level of from about 0.005% to about 0.2% by weight of the usage composition;
N-[1,3-bis(hydroxymethyl)2,5-dioxo-4-imidazolidinyl]-N,N′-bis(hydroxymethyl)urea, commonly known as diazolidinyl urea, available under the trade name Germall II® from Sutton Laboratories, Inc. (Sutton) can be used as the preservative in the present invention. When Germall II is used as the preservative in the present invention, it is typically present at a level of from about 0.01% to about 0.1% by weight of the usage composition;
N,N″-methylenebis {N′-[1-(hydroxymethyl)-2,5-dioxo-4-imidazolidinyl]urea}, commonly known as imidazolidinyl urea, available, e.g., under the trade name Abiol® from 3V-Sigma, Unicide U-13 from Induchem, Germall 115® from (Sutton) can be used as the preservative in the present invention. When imidazolidinyl urea is used as the preservative, it is typically present at a level of from about 0.05% to about 0.2%, by weight of the usage composition.

Mixtures of the preferred imidazolidinedione compounds can also be used as the preservative in the present invention.

(b) Polymethoxy Bicyclic Oxazolidine

Another preferred water-soluble cyclic organic nitrogen preservative is polymethoxy bicyclic oxazolidine, having the general formula:

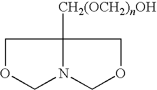

where n has a value of from about 0 to about 5, and is available under the trade name Nuosept® C from Hills America. When Nuosept® C is used as the preservative, it is typically present at a level of from about 0.005% to about 0.1%, by weight of the usage composition.

Mixtures of the preferred cyclic organic nitrogen compounds can also be used as the preservative in the present invention.

### (4). Low Molecular Weight Aldehydes

(a). Formaldehyde

A preferred preservative for use in the present invention is formaldehyde. Formaldehyde is a broad spectrum preservative which is normally available as formalin which is a 37% aqueous solution of formaldehyde. When formaldehyde is used as the preservative in the present invention, typical levels are from about 0.003% to about 0.2%, preferably from about 0.008% to about 0.1%. more preferably from about 0.01% to about 0.05%, by weight of the usage composition.

(b). Glutaraldehyde

A preferred preservative for use in the present invention is glutaraldehyde. Glutaraldehyde is a water-soluble, broad spectrum preservative commonly available as a 25% or a 50% solution in water. When glutaraldehyde is used as the preservative in the present invention it is typically present at a level of from about 0.005% to about 0.1%, preferably from about 0.01% to about 0.05%, by weight of the usage composition.

### (5). Dehydroacetic Acid

A preferred preservative for use in the present invention is dehydroacetic acid. Dehydroacetic acid is a broad spectrum preservative preferably in the form of a sodium or a potassium salt so that it is water-soluble. This preservative acts more as a biostatic preservative than a biocidal preservative. When dehydroacetic acid is used as the preservative it is typically used at a level of from about 0.005% to about 0.2%, preferably from about 0.008% to about 0.1%, more preferably from about 0.01% to about 0.05%, by weight of the usage composition.

### (6). Phenyl and Phenolic Compounds

Some non-limiting examples of phenyl and phenolic compounds suitable for use in the present invention are:
4,4′-diamidino-α,ω)-diphenoxypropane diisethionate, commonly known as propamidine isethionate, with water solubility of about 16%; and 4,4′-diamidino-α,ω)-diphenoxyhexane diisethionate, commonly known as hexamidine isethionate. Typical effective level of these salts is about 0.0002% to about 0.05% by weight of the usage composition.

Other examples are benzyl alcohol, with a water solubility of about 4%; 2-phenylethanol, with a water solubility of about 2%; and 2-phenoxyethanol, with a water solubility of about 2.67%; typical effective level of these phenyl and phenoxy alcohol is from about 0.1% to about 0.5%, by weight of the usage composition. Preferred for use herein is benzyl alcohol.

### (7). Parabens

Short chain alkyl esters of p-hydroxybenzoic acid are commonly known as parabens. Preferred parabens include N-(4-chlorophenyl)-N′-(3,4-dichlorophenyl)urea, also known as 3,4,4′-trichlorocarbanilide or triclocarban; 2,4,4′-trichloro-2′-hydroxy diphenyl ether, commonly known as triclosan.

### (8). Mixtures Thereof

The preservatives of the present invention can be used in mixtures in order to control a broad range of microorganisms.

### Cyclodextrins

Preferably the composition of the invention comprises from about 0.01% to about 20%, more preferably from about 0.05% to about 5% and more preferably from about 0.06% to about 2% by weight of the composition of cyclodextrins.

As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The specific coupling and conformation of the glucose units give the cyclodextrins rigid, conical molecular structures with hollow interiors of specific volumes. The unique shape and physical-chemical properties of the cavity enable the cyclodextrin molecules to absorb (form inclusion complexes with) organic molecules or parts of organic molecules which can fit into the cavity. Many odorous molecules can fit into the cavity including many malodorous molecules and perfume molecules. Therefore, cyclodextrins, and especially mixtures of cyclodextrins with different size cavities, can be used to control odors caused by a broad spectrum of organic odoriferous materials, which may, or may not, contain reactive functional groups. The cavities within the cyclodextrin in the solution of the fabric refreshing composition should remain essentially unfilled (the cyclodextrin remains uncomplexed) while in solution, in order to allow the cyclodextrin to absorb various odor molecules when the solution is applied to a surface. Preferably, the cyclodextrins used herein are highly water-soluble such as, alpha-cyclodextrin and/or derivatives thereof, gamma-cyclodextrin and/or derivatives thereof, derivatised beta-cyclodextrins, and/or mixtures thereof. The derivatives of cyclodextrin consist mainly of molecules wherein some of the —OH groups are converted to —OR groups. Cyclodextrin derivatives include, e.g., those with short chain alkyl groups such as methylated cyclodextrins, and ethylated cyclodextrins, wherein R is a methyl or an ethyl group; those with hydroxyalkyl substituted groups, such as hydroxypropyl cyclodextrins and/or hydroxyethyl cyclodextrins, wherein R is a —CH₂—CH(OH)—CH₃ or a —CH₂CH₂—OH group; branched cyclodextrins such as maltose-bonded cyclodextrins; cationic cyclodextrins such as those containing 2-hydroxy-3-(dimethylamino)propyl ether, wherein R is —CH₂—CH(OH)—CH₂—N(CH₃)₂ which is cationic at low pH; quaternary ammonium, e.g., 2-hydroxy-3-(trimethylammonio)propyl ether chloride groups, wherein R is —CH₂—CH(OH)—CH₂—N±(CH₃)₃Cl⁻; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyclomalto structure, e.g., the mono-3-6-anhydrocyclodextrins, as disclosed in “Optimal Performances with Minimal Chemical Modification of Cyclodextrins”, F. Diedaini-Pilard and B. Perly, The 7th International Cyclodextrin Symposium Abstracts, April 1994, p. 49, said references being incorporated herein by reference; and mixtures thereof. Other cyclodextrin derivatives are disclosed in U.S. Pat. Nos. 3,426,011, Parmerter et al., issued Feb. 4, 1969; 3,453,257; 3,453,258; 3,453,259; and 3,453,260, all in the names of Parmerter et al., and all issued Jul. 1, 1969; 3,459,731, Gramera et al., issued Aug. 5, 1969; 3,553,191, Parmerter et al., issued Jan. 5, 1971; 3,565,887, Parmerter et al., issued eb. 23, 1971; 4,535,152, Szejtli et al., issued Aug. 13, 1985; 4,616,008, Hirai et al., issued Oct. 7, 1986; 4,678,598, Ogino et al., issued Jul. 7, 1987; 4,638,058, Brandt et al., issued Jan. 20, 1987; and 4,746,734, Tsuchiyama et al., issued May 24, 1988; all of said patents being incorporated herein by reference.

Highly water-soluble cyclodextrins are those having water solubility of at least about 10 g in 100 ml of water at room temperature, preferably at least about 20 g in 100 ml of water, more preferably at least about 25 g in 100 ml of water at room temperature. The availability of solubilized, uncomplexed cyclodextrins is essential for effective and efficient odor control performance. Solubilized, water-soluble cyclodextrin can exhibit more efficient odor control performance than non-water-soluble cyclodextrin when deposited onto surfaces, especially fabric. Examples of preferred water-soluble cyclodextrin derivatives suitable for use herein are hydroxypropyl alpha-cyclodextrin, methylated alpha-cyclodextrin, methylated beta-cyclodextrin, hydroxyethyl beta-cyclodextrin, and hydroxypropyl beta-cyclodextrin. Hydroxyalkyl cyclodextrin derivatives preferably have a degree of substitution of from about 1 to about 14, more preferably from about 1.5 to about 7, wherein the total number of —OR groups per cyclodextrin is defined as the degree of substitution. Methylated cyclodextrin derivatives typically have a degree of substitution of from about 1 to about 18, preferably from about 3 to about 16. A known methylated beta-cyclodextrin is heptakis-2,6-di-O-methyl-β-cyclodextrin, commonly known as DIMEB, in which each glucose unit has about 2 methyl groups with a degree of substitution of about 14. A preferred, more commercially available, methylated beta-cyclodextrin is a randomly methylated beta-cyclodextrin, commonly known as RAMEB, having different degrees of substitution, normally of about 12.6. RAMEB is more preferred than DIMEB, since DIMEB affects the surface activity of the preferred surfactants more than RAMEB. The preferred cyclodextrins are available, e.g., from Cerestar USA, Inc. and Wacker Chemicals (USA), Inc.

It is also preferable to use a mixture of cyclodextrins. Such mixtures absorb odors more broadly by complexing with a wider range of odoriferous molecules having a wider range of molecular sizes. Preferably at least a portion of the cyclodextrins is alpha-cyclodextrin and its derivatives thereof, gamma-cyclodextrin and its derivatives thereof, and/or derivatised beta-cyclodextrin, more preferably a mixture of alpha-cyclodextrin, or an alpha-cyclodextrin derivative, and derivatised beta-cyclodextrin, even more preferably a mixture of derivatised alpha-cyclodextrin and derivatised beta-cyclodextrin, most preferably a mixture of hydroxypropyl alpha-cyclodextrin and hydroxypropyl beta-cyclodextrin, and/or a mixture of methylated alpha-cyclodextrin and methylated beta-cyclodextrin.

### Optional Ingredients

The composition herein may further contain one or more optional ingredients typically used in fabric care product category. Illustrative optional ingredients include, but are not limited to surfactant, fabric wrinkle control agent, fabric softening agent, anti-static agent, chelating agent, insect and moth repelling agent, colorant and mixtures thereof. The total level of optional ingredients is low, preferably less than about 5%, or less than about 3%, or less than about 2%, by weight of the composition.

In a preferred embodiment, the composition herein contains from about 0.005% to 0.1% or from about 0.01% to about 0.5% by weight of a surfactant. Preferred surfactants for use herein include siloxane surfactants. Surfactant provides a low surface tension that permits the composition to spread readily and more uniformly on hydrophobic surfaces, such as polyester and nylon. It has been found that perfume compositions containing surfactant spreads satisfactorily on fabric articles. The spreading of the composition also allows it to dry faster, making the drying process more efficient. Furthermore, a composition containing a surfactant can penetrate hydrophobic, oily soil better for improved malodor control. The surfactant is also needed in a composition herein as a dispersing agent, an emulsifying agent and preferably as a solubilizing agent. The surfactant for use herein should be compatible with other components in the composition and not alter the character of the perfume.

Optionally, the composition contains from about 0.1% to about 10%, or from about 0.5% to about 7%, or from about 1% to about 5%, by weight of a fabric wrinkle control agent, preferably selected from the group consisting of: silicone, shape retention polymer, hydrophilic plasticizer, lithium salt, and mixtures thereof. Silicone can be used herein to impart a lubricating property or increased gliding ability to fibers in fabric, particularly clothing. The preferred silicones have pendant alkyl groups having less than about 8, preferably less than about 6, carbon atoms, and do not have pendant aryl groups. Nonlimiting examples of useful silicones include noncurable silicones such as polydimethylsilicone and volatile silicones, and curable silicones such as aminosilicones and hydroxysilicones. Optionally, the composition can contain hydrophilic plasticizer to soften both the fabric fibers, especially cotton fibers. Examples of preferred hydrophilic plasticizers are short chain polyhydric alcohols, such as glycerol, ethylene glycol, propylene glycol, diethylene glycol, dipropylene glycol, sorbitol, erythritol or mixtures thereof, more preferably diethylene glycol, dipropylene glycol, ethylene glycol, propylene glycol and mixtures thereof. Lithium salts can be used in the composition to improve fabric wrinkle control performance. Non-limiting examples of lithium salts that are useful herein are lithium bromide, lithium bromide hydrate, lithium chloride, lithium chloride hydrate, lithium acetate, lithium acetate dihydrate, lithium lactate, lithium sulfate, lithium sulfate monohydrate, lithium tartrate, lithium bitartrate, and mixtures thereof.

### Laundry Appliances

A tumble dryer is a household appliance traditionally used to remove the moisture from a load of fabrics (clothing and other textiles), generally shortly after they are cleaned in a washing machine.

Most dryers consist of a rotating drum through which heated air is circulated to evaporate the moisture from the load. The drum is usually rotated relatively slowly in order to maintain space between the articles in the load. In most cases, the tumbler is motor driven, preferably belt-driven by an induction motor. Some dryers use a single motor to tumble the drum and to produce the air current. It has been found herein that dryers with two independent motors, one for the drum and another one to generate the air current give more flexibility of operation, allowing the delivery of the perfume composition when the drum is tumbling without air current, thereby favoring level and evenness of deposition. This has also been found particularly suitable in the case of dry loads.

The appliances for use in the method of the invention have a liquid delivery system to deliver the perfume composition into the drum.

While not wishing to be limited by theory it is believed that some factors which may possibly influence both uniformity of distribution and deposition of the perfume composition onto the fabric in the drum of a laundry appliance include flowrate of the perfume composition in the drum, the droplet size of the perfume composition, the position of the nozzle in the drum, the cone angle of the spray in the drum, the linear velocity of the perfume composition in the drum, etc.

The placement of the nozzle and angle of the nozzle should be chosen so as to optimize the spray contact with the fabric article in the appliance. A very effective way (in terms of uniform and efficient fabric coverage) of delivering the treatment solution is to select an angle such that the nozzle is not directly aimed at the dryer vent/lint screen or at the top of the drum. Furthermore, it is generally desirable that the nozzle be angled such that the spray from the nozzle is delivered through the void space/tunnel created by the tumbling of the fabrics around the perimeter of the appliance drum so as to contact the fabrics at the bottom of the rotating circle of fabrics. Also it may be effective that the nozzle be angled such that the spray intercepts the fabrics being tumbled in the appliance as the fabrics drop from their highest vertical point to their lowest vertical point during drum rotation.

Dryers suitable for the method of the invention can optionally have a venting system. Preferred for use herein are dryers without a venting system, because they are more efficient in terms of treatment solution usage. In dryers with venting systems is preferred that the delivery of the treatment solution takes place with the venting system closed (to avoid losses).

Preferably, the perfume composition is delivered onto the fabric in the form of a spray having droplets with mean droplet size of from about 100 microns to about 1400 microns, more preferably form about 200 microns to about 1300 microns, even more preferably from about 300 microns to about 1200 microns and especially from about 500 microns to about 1100 microns. It is also preferred that droplet size distribution is such that less than 10% of the droplets have a size of less than 50 microns and less than 10% have a size greater than 1600 microns. By “size” is herein meant the diameter of the droplets. This droplet size range contributes to good distribution of the perfume composition and avoids streaking and staining of the fabrics.

A suitable instrument for measuring droplet size is the Malvern particle sizer manufactured by Malvern Instruments Ltd. of Framingham, Mass.

The flowrate of the spray in the drum is preferably from about 0.5 to about 100 ml/minute, more preferably from about 1 to about 75 ml/minute, even more preferably from about 2 to about 50 ml/minute and especially from about 15 to about 25 ml/minute. One suitable method for determining flow rate is found in ASME/ANSI MFC-9M-1988, entitled “Measurement of Liquid Flow in Closed Conduits by Weighing Method”.

Preferably, the linear velocity of the spray in the drum is from about 0.05 to about 2 m/second, more preferably from about 0.1 to about 1 m/second. The length of the spray in the drum of the tumble dryer is from about 20% to about 95% of the length of the drum as measured along the rotational axis of the drum. One suitable method for determining linear velocity is by utilizing Laser Doppler Anemometry such as described in “Laser Doppler and Phase Doppler Measurement Techniques” part of the “Experimental Fluid Mechanics” series, written by Albrecht, H. E., Damaschke, N., Borys, M., and Tropea, C., 2003, XIV, 738, page 382.

The cone angle of the spray refers to the angle the spray forms as it is sprayed into the drum of the tumble dryer. The cone angle of the spray is about 35° to about 150° or about 40° to about 110° or about 50° to about 90°.

All the percentages given herein are weight basis unless otherwise stated. The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

### EXAMPLES

### Delivery in a Dryer

The perfume composition exemplified in Table 1 is added to a suitably equipped dryer containing a port for addition, a reservoir, a pump to transfer the composition to the fabric articles in the drum and a nozzle within the drum to deliver the composition. The spray feature can be activated on any drying cycle based on the users input. When a predetermined level of fabric dryness (less than 0.5 L of moisture per Kilogram of fabric) has been reached the spray phase of the cycle is activated. Firstly the heater is disengaged and during the cool down, with the drum still revolving, 50 mL of the perfume composition is delivered at a rate of 60 mL/minute according to the sequence outlined below in Table 3. During the drying process the laundry room is filled with perfume. The dry fabric articles are nicely perfume at the end of the drying.

TABLE 1
Perfume composition

| Ingredient | Wt. % |
|---|---|
| Preservative¹ | 0.02 |
| Silwet 7600² | 0.098 |
| Basophor³ | 0.027 |
| Benzyl Alcohol | 0.030 |
| Perfume⁴ | 0.118 |
| Hydroxypropyl β Cyclodextrin | 0.581 |
| Distilled Water | Up to 100 |

¹Koralone B-119 (1,2 benzisothiazolin 3-one) available from Rhom and Haas
²Silicon surfactant available from GE
³Surfactant available from BASF
⁴Perfume exemplified in Table 2

TABLE 2
Perfume

| Perfume Ingredients | Wt. % | Clog P | BP |
|---|---|---|---|
| Blooming Ingredients | | | |
| Beta Pinene | 0.08 | 4.18 | 166 |
| Citronellyl Acetate | 3.97 | 4.2 | 234 |
| Decyl Aldehyde | 1.75 | 4.01 | 208 |
| Delta Damascone | 0.39 | 3.62 | 256 |
| d-Limonene | 17.7 | 4.35 | 177 |
| Lorysia | 1.4 | 4.06 | 235 |
| Lymolene | 8.5 | 3.03 | 198 |
| Para Cymene | 0.15 | 4.07 | 173 |
| Terpineolene | 10 | 4.35 | 172 |
| Tetra Hydro Linalool | 13.52 | 3.52 | 202 |
| Fabric Substantive | | | |
| ingredients | | | |
| Citrathal | 0.38 | 3.93 | 262 |
| Clonal | 0.16 | 4.9 | 267 |
| Cyclabute | 1.59 | 3.41 | 275 |
| Florhydral | 0.08 | 3.55 | 277 |
| Nectaryl | 2.39 | 4.43 | 317 |
| Neobutenone | 0.16 | 3.63 | 266 |
| Nonadienenitrile, 3,7-dimethyl | 4.12 | 3.77 | 262 |
| Other Ingredients | | | |
| Methyl Dihydro Jasmonate | 9.68 | 2.42 | 314 |
| Allyl Amyl Glycolate | 0.12 | 2.38 | 218 |
| Allyl Caproate | 1.59 | 2.87 | 186 |
| Ethyl-2-methyl Butyrate | 5.57 | 2.08 | 131 |
| Eucalyptol | 0.63 | 2.76 | 176 |
| Flor Acetate | 2.11 | 2.36 | 233 |
| Frutene | 2.11 | 2.89 | 250 |
| trans-Geraniol | 2.7 | 2.77 | 230 |
| Ligustral | 4.05 | 2.36 | 204 |
| Linalool | 0.9 | 255 | 193 |
| Methyl Pamplemousse | 1.31 | 2.7 | 194 |
| Octyl Aldehyde | 1.25 | 2.95 | 167 |
| Phenyl Ethyl Alcohol | 0.45 | 1.18 | 218 |
| Prenyl Acetate | 0.4 | 1.68 | 150 |
| Violiff | 0.79 | 2.77 | 238 |

TABLE 3
Delivery regime in the dryer
Minutes into spray phase (i.e. after drying is complete)

| 0 | 1 | 2 | 3 | 4 | 5 | 6 | 7 |
|---|---|---|---|---|---|---|---|
| Spray duration (seconds)/ | 12.5/12.5 | | 12.5/12.5 | | 12.5/12.5 | | 12.5/12.5 |
| Spray volume (ml) | | | | | | | |
| Drum rotation | On | | | | | | |
| Heater | Off | | | | | | |

Total Spray 50 ml

### Delivery in a Washing Machine

The perfume composition according to Table 1 is added to a suitably equipped washing machine that features a reservoir for adding the benefit composition, and a delivery system for transfer of the perfume composition from reservoir to the internal drum. An example of the delivery system is a tube connecting the reservoir to a nozzle situated inside the drum via a pump. Following the rinse phase of a wash cycle 50 mL of the perfume composition is sprayed onto the fabric articles within the drum whilst the drum is turning. Drum rotation continues for 4 mins followed by the spin phase of the cycle. The fabric articles are then dried either on a laundry line or a dryer (either a separate tumble dryer or in the washing machine, if the machine is washing/dryer). The laundry room is nicely perfumed during the drying process and the fabric articles end up nicely perfumed.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of perfuming a fabric article in a dryer comprising the steps of:
a) placing the article in the dryer;
b) delivering a perfume composition onto the article having a level of moisture of less than about 0.5 L/Kg and wherein the composition comprises:
i) from 0.01% to 10% by weight of the composition of perfume and the perfume comprises:
at least 5% by weight of perfume blooming ingredients having a boiling point at 1 atmosphere of less than 260° C. and preferably a Clog P greater than 3 at 25° C.; and
at least 1% by weight of perfume fabric substantive ingredients having a boiling point at 1 atmosphere of more than 260° C. and a Clog P greater than 3 at 25° C.; and
ii) from 0.01% to 10% by weight of the composition of a preservative.

2. A method according to claim 1 wherein the perfume composition is delivered onto a dry article.

3. A method according to claim 1 wherein the dryer has a drum capable of tumbling, an air inlet, an air current provider, an air outlet having a lint screen and optionally a venting system and wherein the delivery of the perfume composition takes place when the drum is tumbling.

4. A method of perfuming a fabric article in a washing machine comprising the steps of:
a) placing the article in the washing machine;
b) delivering a perfume composition after the rinse cycle onto the article wherein the composition comprises:
i) from 0.01% to 10% by weight of the composition of perfume and the perfume comprises:
at least 5% by weight of perfume blooming ingredients having a boiling point at 1 atmosphere of less than 260° C. and preferably a Clog P at 25° C. greater than 3; and
at least 1% by weight of perfume fabric substantive ingredients having a boiling point at 1 atmosphere of more than 260° C. and a Clog P at 25° C. greater than 3; and
ii) from 0.01% to 10% of a preservative.

5. A method according to claim 1 wherein the preservative is selected from chelants, organic sulphur compounds, halogenated compounds, cyclic organic nitrogen compounds, low molecular weight aldehydes, dehydroacetic acid, phenyl and phenolic compounds and parabens.

6. A method according to claim 1 wherein the delivery of the perfume composition takes place intermittently.

7. A method according to claim 1 wherein the dryer or the washing machine comprises a liquid delivery system comprising an inlet, a reservoir, a delivery means and an outlet.

8. A method according to claim 7 wherein the delivery means comprises a pump, and optionally electrostatic means, ultrasonic means or a mixture thereof.

9. A method according to claim 7 wherein the outlet of the liquid delivery system is in the form of a nozzle or a plurality of nozzles.

10. A method according to claim 1 wherein the perfume composition is delivered in the form of a spray and wherein the spray has:
a) droplets having a mean particle size of from about 100 microns to about 1400 microns; and
b) a flowrate of from about 0.5 to about 100 ml/min.

11. A method according to claim 1 wherein the perfume composition comprises a deodorizing agent.
